(19) United States
(12) Patent Application Publication
(10) Pub. No.: US 2019/0286664 A1
(43) Pub. Date: Sep. 19, 2019

(54) ELECTRONIC CONTENT SEARCH SYSTEM

(71) Applicant: Northern Lake Innovations, LLC, Madison, WI (US)

(72) Inventor: Michael Levan Adams, Columbus, OH (US)

(21) Appl. No.: 16/353,103

(22) Filed: Mar. 14, 2019

Related U.S. Application Data
(60) Provisional application No. 62/643,237, filed on Mar. 15, 2018.

(51) Int. Cl. G06F 16/9035; G06F 16/9032; G06N 20/00; G06K 9/62

(52) U.S. Cl. CPC G06F 16/9035; G06K 9/6263; G06N 20/00; G06F 16/90332

(57) ABSTRACT

An example electronic content management system receives a corpus of content from a plurality of proprietary electronic content management systems by providing an agnostic conversion process that accepts the content in multiple forms and converts the multiple forms into content for the electronic content management system. The system also enriches the corpus of content using a model, receives a query from a user, identifies content from the corpus of content relevant to that query, and provides aspects of that content to the user as results of the query.

### BACKGROUND

Electronic content management systems house massive amounts of electronic content, such as documents and media, for organizations. However, once that electronic content is created and stored, it can be difficult to identify and access. This can result in upwards of 80 percent of electronic content going “dark”—seldom or never to be accessed from the electronic content management systems due to problems finding and delivering relevant content to users in an efficient manner.

### SUMMARY

In one aspect, an example electronic content management system includes: at least one processor; and system memory encoding instruction that, when executed by the at least one processor, causes the at least one processor to: receive a corpus of content from a plurality of proprietary electronic content management systems by providing an agnostic conversion process that accepts the content in multiple forms and converts the multiple forms into content for the electronic content management system; enrich the corpus of content using a model; receive a query from a user; identify content from the corpus of content relevant to that query; and provide aspects of that content to the user as results of the query.

In another aspect, an example method for managing electronic content includes: providing an agnostic conversion process that accepts the content in multiple forms and converts the multiple forms into a corpus of content; enriching the corpus of content using a model; creating an application programming interface to receive the query; receiving a query from a user at the application programming interface; creating a discovery module programmed to extract an intent from the query; identify content from the corpus of content relevant to that query; and providing aspects of that content to the user as results of the query.

### DESCRIPTION OF THE DRAWINGS

FIG. 1 illustrates an example electronic content management system.

FIG. 2 illustrates an example electronic content management device of the system of FIG. 1.

FIG. 3 illustrates example aspects of the corpus of content of the electronic content management device of FIG. 2.

FIG. 4 illustrates an example method for the electronic content management device of FIG. 2.

FIG. 5 illustrates additional aspects of the example method of FIG. 4.

FIG. 6 illustrates example physical components of the electronic content management device of FIG. 2.

### DETAILED DESCRIPTION

The present disclosure is directed to electronic content management systems. In these examples, some of the electronic content management systems are flexible, allowing for the efficient ingestion and enrichment of content into the system. Further, some of the electronic content management systems include robust feedback mechanisms that enhance the ingestion and enrichment of the electronic content.

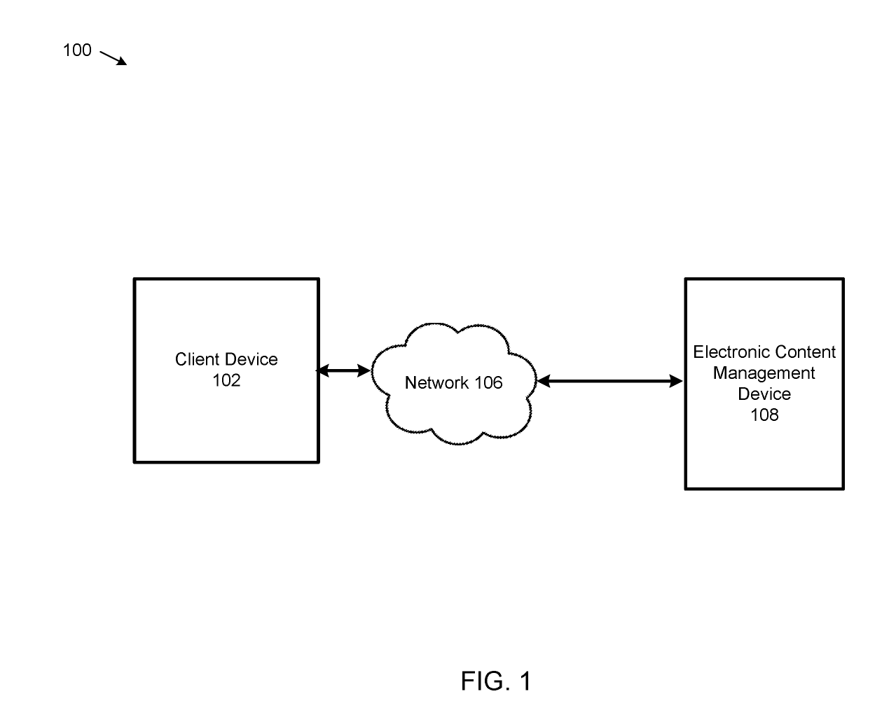

Referring now to FIG. 1, an example document management system 100 is shown including a client device 102 and an electronic content management device 108.

The electronic content management device 108 is one or (more typically) more computing devices that house electronic content. One example of such an electronic content management device 108 is IBM Content Foundation from IBM.

The client device 102 is a computing device, such as a mobile device or desktop computer. The client device 102 communicates with the electronic management device 108 through a network 106 to access electronic content managed by the electronic content management device 108. This process is described further below.

Although a client device 102 is shown in this example, in practice, hundreds or thousands of client devices 102 can access content from the electronic content management device 108.

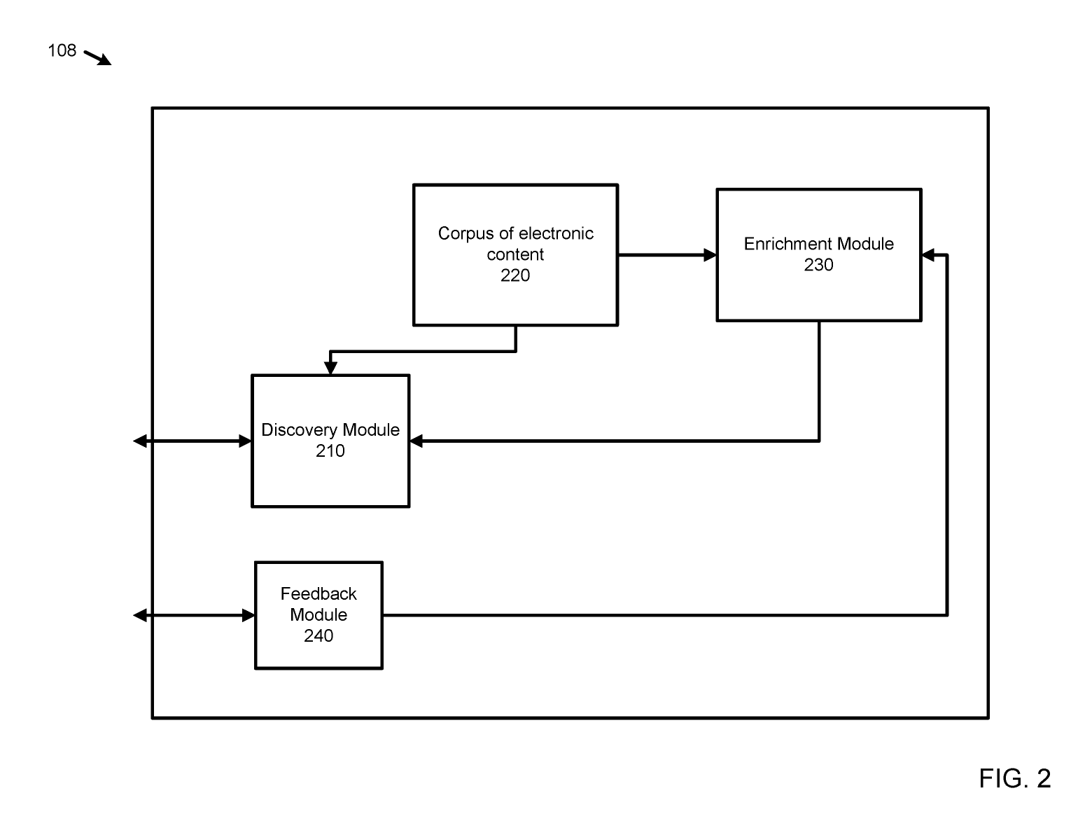

Referring now to FIG. 2, example components of the electronic content management device 108 are shown.

In these examples, the electronic content management device 108 communicates through using one or more application programmer interfaces (APIs) using a standard communication scheme, such as JavaScript Object Notation (JSON). In this example, the electronic content management device 108 includes a discovery module 210 that communicates with the client device 102. For example, the client device 102 can include an interface that allows the user to create a query for content in the electronic content management device 108.

In one example, the user uses natural language input to form the query. For example, the user can input a query using a keyboard or voice. The client device 102 is programmed to determine when the query is well-formed. In some examples, the client device 102 can even be programmed to modify or otherwise request additional information from the user as the query is formed.

For example, in one embodiment, the client device 102 is programmed to receive a natural language query presented by the user orally, such as in a conversational environment in which the user interacts with the client device 102. Once the query is received, the client device 102 (or, in some instances, the electronic content management device 108) determines if enough information provided by the user justifies a query to the electronic content management device 108. If not, the client device 102 can be programmed to request additional information from the user (e.g., in a conversational format) until a full-formed query is reached.

Once a full-formed query for electronic content is formed, the client device 102 sends that query through an API to the electronic content management device 108. Specifically, the query is received by a discovery module 210 of the electronic content management device 108. Generally, the discovery module 210 manages the query and identifies content in a corpus of electronic content 220 that is responsive to that query. In one example, the discovery module 210 is the Watson Discovery Service from IBM, although other configurations are possible.

The discovery module 210 extracts the intent from the query using one or more dictionaries that are described further below. The discovery module 210 then identifies content from the corpus of electronic content 220 that most closely corresponds to the intent from the query of the user. Information about that content is returned to the client device 102 for the user's review. The returned results can include aspects about the content, such as content name and metadata associated with the content. The aspects can also include a snippet of a relevant portion of the content.

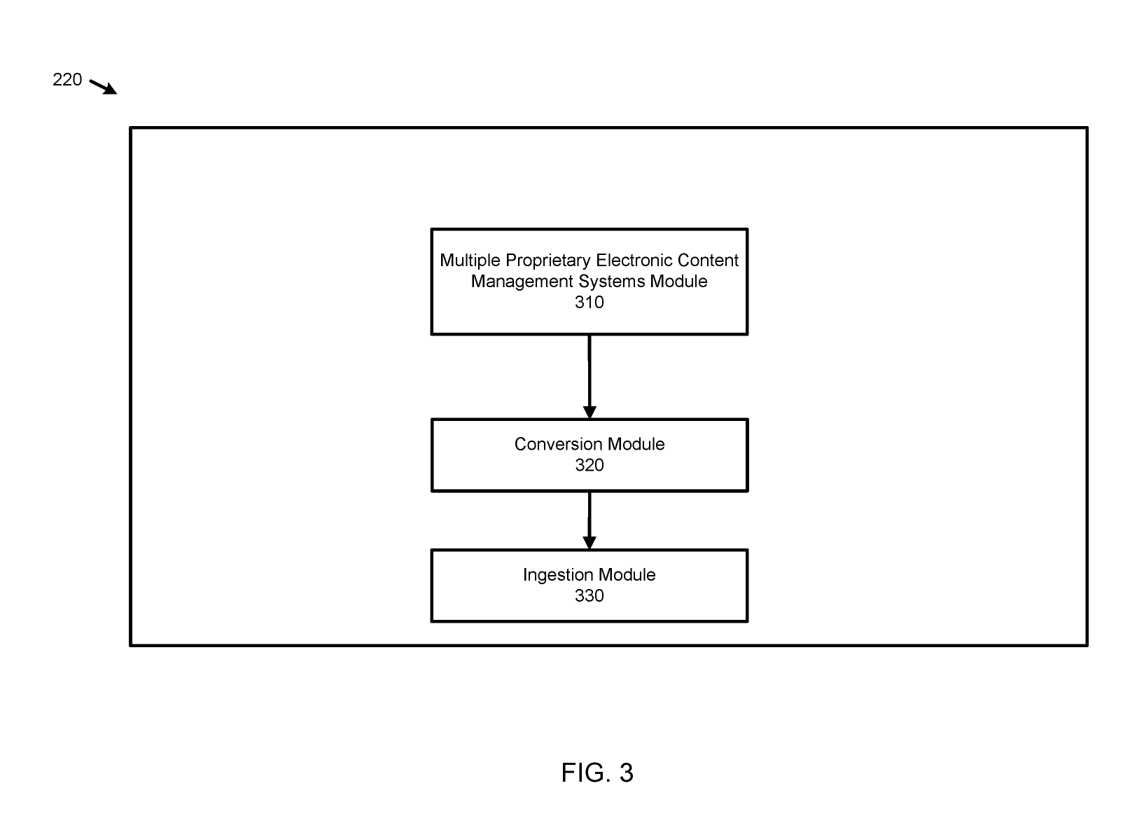

Referring to FIG. 3, the electronic content management device 108 is programmed to add flexibility when managing the corpus of electronic content 220. Example modules providing flexible functionality include multiple proprietary electronic content management systems module 310, conversion module 320, and ingestion module 330.

Commercially available electronic document management systems typically include their own metadata, storage and security architecture and methods within proprietary formats. Native storage systems (network file storage, native operating system file storage) have their own direct and indirect access properties. Multiple proprietary electronic content management systems module 310 interfaces with, and receives documents from, various proprietary electronic content management systems. Example proprietary electronic content management systems include, but are not limited to, M-Files, Laserfiche, iManage, Dropbox, SharePoint, Docuware, box, net documents, etc.

Respectively, each electronic content management system may have export or file transfer functions limited to documents within its own discrete repository or file structure. The ingestion module 330, for example Watson Discovery Services, includes a process for accepting these discrete exported documents in one or more native file formats (.doc, .pdf, etc.).

Using existing electronic content management conversion services, such as that provided by FileFacets (www.filefacets.com), module 310 can export documents from multiple electronic content management systems and, in turn, deposit the documents into the ingestion module 330. However, these files are provided without a common structured data file format that includes comprehensive structured metadata, annotation, document access security information, native document system access path, and training model refinement information.

In the present system, a conversion module 320 is provided that is programmed to provide a new conversion output format for these services, explicitly designed to support transfer from any of their supported input ECMs agnostically, allowing the electronic content management device 108 to support content from the multiple proprietary electronic content management systems for ingestion, enrichment and query.

The conversion module 320 includes a descriptor format that permits simultaneous transmission of metadata and enrichment usable by components of the system respectively: ingestion by an ingestion module 330, training, application, and presentation and access to the final results.

In one example, the conversion module 320 is programmed to allow the components of the conversion to be aggregated and deposited as a single payload containing:
(i) native original content in displayable file format (docx, pdf, text, html, etc.);
(ii) uniform resource locator (URL) associated with the content in its original repository, if the native content is to be displayed directly from that repository;
(iii) extracted text or html-tagged text from original content (UTF-8 text format);
(iv) abbreviated content snippets of 1000-2000 words for potential manual annotation;
(v) annotation dictionary libraries (in comma delimited UTF-8 format of lemma), part of speech, and the surface forms associated with each unique lemma; and
(vi) pre-annotated content in a zipped format, in XML Metadata Interchange (XMI) serialization of UIMA Common Analysis Structure (UIMA CAS XMI) including an Unstructured Information Management Architecture (UIMA) Type System descriptor file and a file map that identifies UIMA types to entity types.

Each component in the payload described above is routed to its respective associated process in the model. For example, items i and ii are sent to storage to be served out to the user interface when triggered. Item iii is routed to the discovery module 210. Item iv is routed to manual markup for manual processing of content, if performed. Item v dictionary libraries, and their associated classes, are imported into the enrichment module 230. Item vi content is absorbed into the enrichment module 230 as pre-annotation components.

This results in a system that is agnostic to the proprietary electronic content management system. The electronic content management device 108 can accept documents from a plurality of different proprietary electronic content management systems, consume that content (as described further below), and provide meaningful results to search queries in a seamless manner.

Among other advantages, this permits the ingestion module 330 to be updated using additional syntactical or grammatical definitions that might be derived from the conversion module 320 automatically at the same time that the content is made available. It also permits the model to be updated at any time that new content is added to any of the multiple proprietary electronic content management systems. In near real time (or, in other instances, at periodic intervals, such as one hour, once every two hours, and/or once per day), as content is added to the multiple proprietary electronic content management systems module 310, that content is converted by the conversion module 320 and ingested by the ingestion module 330.

Referring again to FIG. 2, aspects of the corpus of electronic content 220 is enriched by an enrichment module 230. The enrichment module 230 uses a combination of one or more of machine learning and artificial intelligence to provide a better contextual understanding of the content in the corpus of electronic content 220.

In this example, a series of dictionaries forms one or more models, and the one or more models are used to enrich the content that is consumed.

For example, pre-annotation dictionaries are primarily used to identify and mark mentions and entities in content used to compute a training model. Dictionaries are typically constructed with a single word appearing in the content (e.g., document), its various additional variations that should be treated as equivalent to the same word, the part of speech represented (noun, verb, adjective, etc.), and potentially other relevant information, such as the language of the word. Dictionaries are not customarily used to define synonyms nor works that can have more than one grammatical use, e.g., “rain”—which can be either noun or verb.

Dictionaries are ingested in a described format for individual training systems or can be created or edited manually. They are used as a pre-annotation device to reduce manual intervention and annotation, the presumption being that human annotation, which results in so-called ground truth, should not be trumped by automatic markup.

In addition, the electronic content management device 108 includes a feedback module 240. Generally, the feedback module 240 accepts feedback from the user, re-evaluates the model, changes the model and adjusts the enrichment module 230 accordingly so that more meaningful content can be provided for future queries. Additionally, the new model is then applied to the existing documents in the corpus, as well as any new documents added after the model update.

In the feedback loop described, the system bypasses common numeric or ‘like-dislike’ processing feedback and returns new dictionary definitions, intents and equivalencies from the user responses directly. The feedback thus updates the original dictionary files, and any associated class mapping, to provide discrete control over the level to which the original model can and should be updated, while creating a new corpus of feedback responses from which new and updated training models can be generated.

With this feedback innovation, the system moderators can retest the training model independently using a new aggregation of updated dictionary definitions and the human annotation to create an updated measure of precision and recall, and the choice to re-implement the model on the entire corpus or just succeeding newly-ingested documents.

Specifically, the feedback module 240 allows the user to provide feedback regarding the results of a query. There can be various mechanisms that are used to do so. In one example, the user can simply provide a positive or negative indication to one or more of the search results. In another example, the user can provide additional feedback—such as detailed text describing the relevant value of a search result.

For example, in one embodiment, an indicator (such as 1-4 stars) is provided adjacent each search result. The user can provide feedback by selecting the number of stars based upon the relevancy of the result to the search query. An input box is provided to allow the user to provide a textual description, particularly when the result is not relevant (e.g., allowing the user to voice or type: “This result is not relevant because I asked for content on Brittany Spears, and this result about broccoli spears is not relevant to me.”).

The feedback loop through the feedback module 240 can be programmed to ignore null values, so that, if a user does not act explicitly, the model does not receive any input. Therefore, the same results will appear the next time the same question is posed, absent other input.

In the example shown, the feedback is compiled by the feedback module 240 and provided to the enrichment module 230 to create a newly-annotated training model. The new model, updated with explicit responses from the feedback, is loaded into the enrichment module 230 and applied to the corpus of electronic content 220, including all new content added to the corpus of electronic content 220 going forward.

For example, as described above, users will be prompted to provide feedback on the validity of results. The feedback will accept either text or verbal responses, which will be analyzed (e.g., using a conversation API to determine intent and pose additional questions). If the response indicates incorrect evaluation of a word or term, for example an incorrectly attributed acronym, then the application asks for a new qualifier to add to the dictionary. If the response indicates that the correlation of intent to result is weak or unresponsive, the actual content will be marked for manual examination and reannotation.

In either case, the normal result of refining either dictionary or manual annotation is testing the new annotations within the background to determine if the model generates higher success rates. If so, the model can be uploaded into the enrichment module 230, and the entire corpus or just succeeding new content will be subjected to the newer model.

In this manner, the actual base training is altered permanently. The existing content that has already been enriched can be reanalyzed by the enrichment module 230 using the newly-annotated training model so that future results will better fit queries by the user.

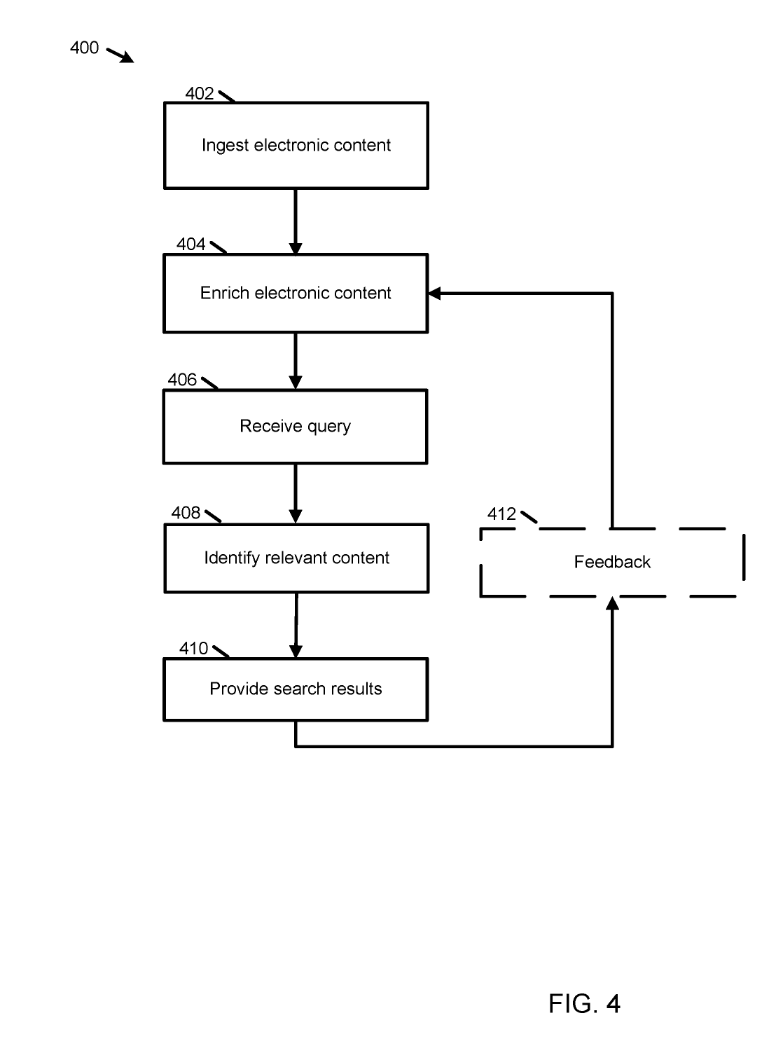

Referring now to FIG. 4, an example method 400 of the electronic content management device 108 is provided.

Initially, at operation 402, content is ingested as described above. As noted, the content from various proprietary electronic content management systems can be ingested in a semi- or full-automated fashion (e.g., without necessary human input) to allow for flexibility in the system.

Next, at operation 404, the content is enriched using machine learning and/or artificial intelligence techniques. In these examples, various dictionaries forming one or more models are used to enrich the content.

At operation 406, a query is received from a client. In this example, the query is a natural language query. Next, at operation 408, the content relevant to that query is identified, and the results are provided to the user at operation 410.

Finally, at optional operation 412, feedback can be received from the user. As noted, this feedback is used to modify the enrichment of the content so that future queries provide more accurate results.

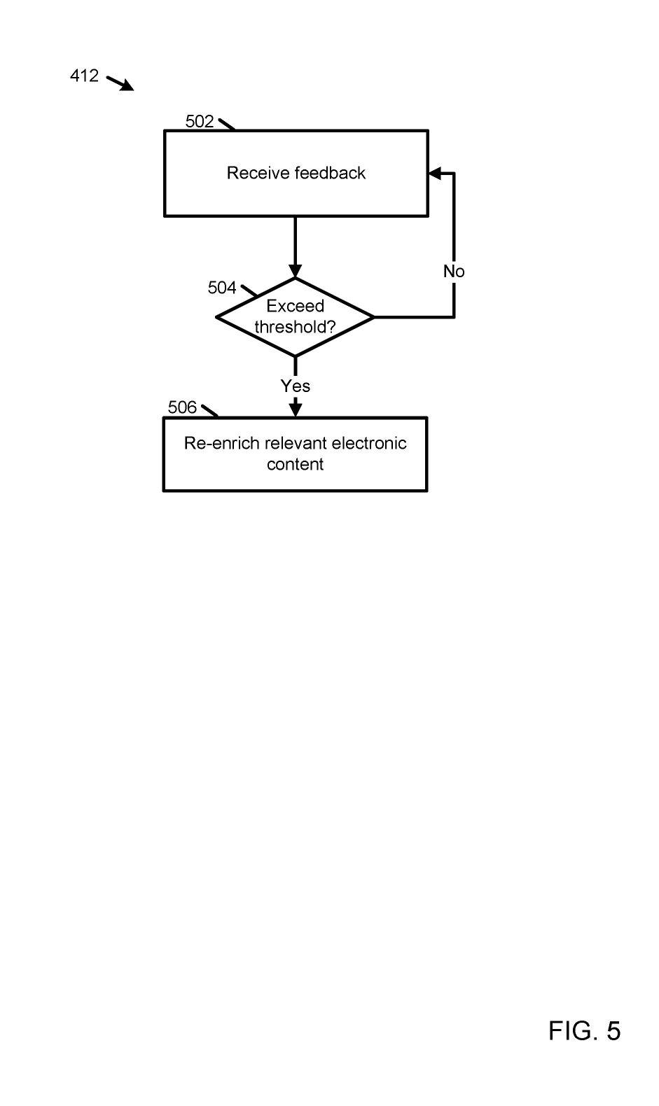

Specifically, additional details on the operation 412 are illustrated in FIG. 5. At operation 502, the feedback is received from the user. As noted, this feedback is quantified, and a determination is made at operation 504 as to whether or not the feedback exceeds a “threshold”. For example, when the feedback is numerical in nature, a determination can be made when the feedback is negative enough to require action. For textual feedback, the system can use one or more artificial mechanisms to determine when the feedback warrants action, as described further above.

If the feedback does exceed the threshold warranting action, control is passed to operation 506, at which point the relevant content is re-enriched using the updated models developed using the feedback.

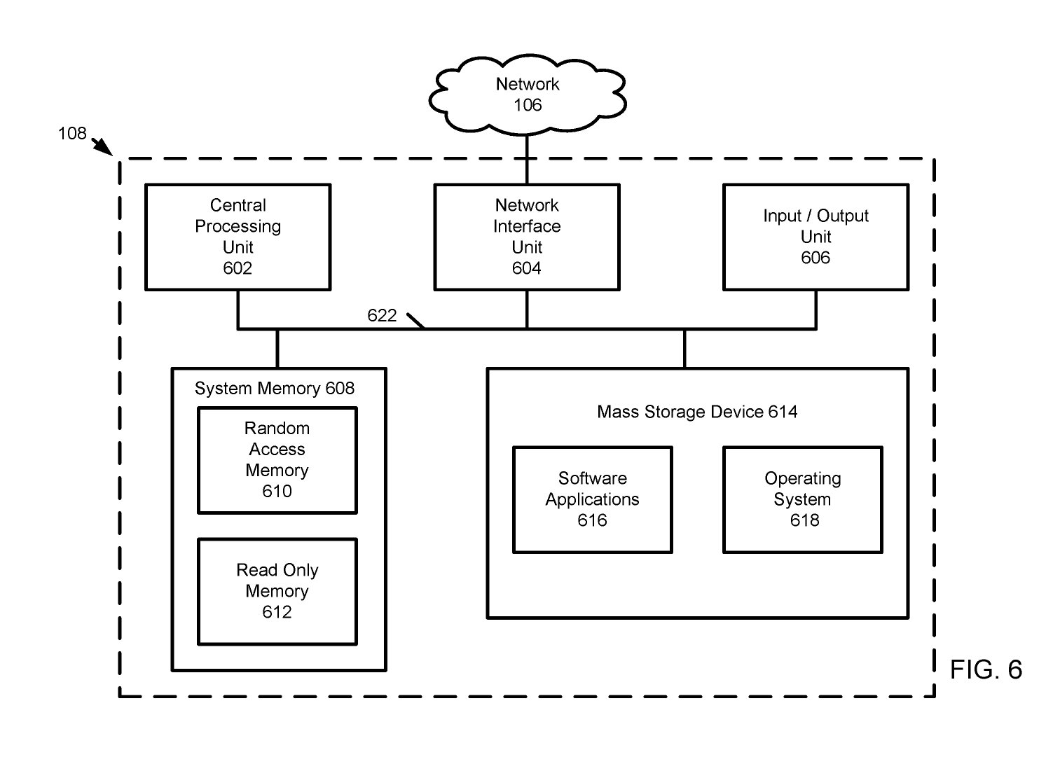

As illustrated in the example of FIG. 6, the electronic content management device 108 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between components within the electronic content management device 108, such as during startup, is stored in the ROM 612. The electronic content management device 108 further includes a mass storage device 614. The mass storage device 614 is able to store software instructions and data. Some or all of the components of the electronic content management device 108 can also be included in the central system 108 and other computing devices described herein.

The mass storage device 614 is connected to the CPU 602 through a mass storage controller (not shown) connected to the system bus 622. The mass storage device 614 and its associated computer-readable data storage media provide non-volatile, non-transitory storage for the electronic content management device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the electronic content management device 108.

According to various embodiments, the electronic content management device 108 may operate in a networked environment using logical connections to remote network devices through the network 106, such as a wireless network, the Internet, or another type of network. The electronic content management device 108 may connect to the network 106 through a network interface unit 604 connected to the system bus 622. It should be appreciated that the network interface unit 604 may also be utilized to connect to other types of networks and remote computing systems. The electronic content management device 108 also includes an input/output controller 606 for receiving and processing input from a number of other devices, including a touch user interface display screen, or another type of input device. Similarly, the input/output controller 606 may provide output to a touch user interface display screen or other type of output device.

As mentioned above, the mass storage device 614 and the RAM 610 of the electronic content management device 108 can store software instructions and data. The software instructions include an operating system 618 suitable for controlling the operation of the electronic content management device 108. The mass storage device 614 and/or the RAM 610 also store software instructions and software applications 616, that when executed by the CPU 602, cause the electronic content management device 108 to provide the functionality discussed in this document. For example, the mass storage device 614 and/or the RAM 610 can store software instructions that, when executed by the CPU 602, cause the electronic content management device 108 to ingest, enrich, and serve up content in response to queries.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electronic content management system, comprising:
at least one processor; and
system memory encoding instruction that, when executed by the at least one processor, causes the at least one processor to:
receive a corpus of content from a plurality of proprietary electronic content management systems by providing an agnostic conversion process that accepts the content in multiple forms and converts the multiple forms into content for the electronic content management system;
enrich the corpus of content using a model;
receive a query from a user;
identify content from the corpus of content relevant to that query; and
provide aspects of that content to the user as results of the query.

2. The electronic content management system of claim 1, wherein the system memory further comprises instructions that, when executed by the at least one processor, causes the at least one processor to:
receive feedback from the user about the aspects;
retrain the model based upon the feedback; and
re-enrich the corpus of content using the retrained model.

3. The electronic content management system of claim 2, wherein the system memory further comprises instructions that, when executed by the at least one processor, causes the at least one processor to act upon the feedback when the feedback exceeds a threshold.

4. The electronic content management system of claim 2, wherein the system memory further comprises instructions that, when executed by the at least one processor, causes the at least one processor to act upon the feedback when the feedback exceeds a numeric threshold.

5. The electronic content management system of claim 1, wherein the system memory further comprises instructions that, when executed by the at least one processor, causes the at least one processor to create an application programming interface to receive the query.

6. The electronic content management system of claim 1, wherein the system memory further comprises instructions that, when executed by the at least one processor, causes the at least one processor to create a discovery module programmed to extract an intent from the query.

7. The electronic content management system of claim 6, wherein the system memory further comprises instructions that, when executed by the at least one processor, causes the discovery module to extract the intent from the query using one or more dictionaries.

8. The electronic content management system of claim 1, wherein the system memory further comprises instructions that, when executed by the at least one processor, causes the at least one processor to create a conversion module programmed to convert outputs from the plurality of proprietary electronic content management systems to the content for the electronic content management system.

9. The electronic content management system of claim 8, wherein the system memory further comprises instructions that, when executed by the at least one processor, causes the conversion module to create a single payload including converted data from each of the plurality of proprietary electronic content management systems.

10. The electronic content management system of claim 8, wherein the system memory further comprises instructions that, when executed by the at least one processor, causes the conversion module to use a descriptor format permitting transmission of enrichment data based upon ingestion from each of the plurality of proprietary electronic content management systems.

11. An electronic content management system, comprising:
at least one processor; and
system memory encoding instruction that, when executed by the at least one processor, causes the at least one processor to:
receive a corpus of content from a plurality of proprietary electronic content management systems by providing an agnostic conversion process that accepts the content in multiple forms and converts the multiple forms into content for the electronic content management system;
enrich the corpus of content using a model;
create an application programming interface to receive the query;
receive a query from a user at the application programming interface;
create a discovery module programmed to extract an intent from the query;
identify content from the corpus of content relevant to that query; and
provide aspects of that content to the user as results of the query.

12. The electronic content management system of claim 1, wherein the system memory further comprises instructions that, when executed by the at least one processor, causes the at least one processor to:
receive feedback from the user about the aspects;
retrain the model based upon the feedback; and
re-enrich the corpus of content using the retrained model.

13. The electronic content management system of claim 12, wherein the system memory further comprises instructions that, when executed by the at least one processor, causes the at least one processor to act upon the feedback when the feedback exceeds a threshold.

14. The electronic content management system of claim 11, wherein the system memory further comprises instructions that, when executed by the at least one processor, causes the discovery module to extract the intent from the query using one or more dictionaries.

15. The electronic content management system of claim 11, wherein the system memory further comprises instructions that, when executed by the at least one processor, causes the at least one processor to create a conversion module programmed to convert outputs from the plurality of proprietary electronic content management systems to the content for the electronic content management system.

16. The electronic content management system of claim 15, wherein the system memory further comprises instructions that, when executed by the at least one processor, causes the conversion module to create a single payload including converted data from each of the plurality of proprietary electronic content management systems.

17. The electronic content management system of claim 15, wherein the system memory further comprises instructions that, when executed by the at least one processor, causes the conversion module to use a descriptor format permitting transmission of enrichment data based upon ingestion from each of the plurality of proprietary electronic content management systems.

18. A method for managing electronic content, comprising:
providing an agnostic conversion process that accepts the content in multiple forms and converts the multiple forms into a corpus of content;
enriching the corpus of content using a model;
creating an application programming interface to receive the query;
receiving a query from a user at the application programming interface;
creating a discovery module programmed to extract an intent from the query;
identify content from the corpus of content relevant to that query; and
providing aspects of that content to the user as results of the query.

19. The method of claim 18, further comprising:
receiving feedback from the user about the aspects;
retraining the model based upon the feedback; and
re-enriching the corpus of content using the retrained model.

20. The method of claim 19, further comprising acting upon the feedback when the feedback exceeds a threshold.
